(19) United States
(12) Patent Application Publication
(10) Pub. No.: US 2026/0023674 A1
(43) Pub. Date: Jan. 22, 2026

(54) AUTOMATIC SCRIPT ERROR DETECTION AND CORRECTION

(71) Applicant: Micro Focus LLC, Wilmington, DE (US)

(72) Inventors: Yan-Jun Yu, Shanghai (CN); Ye Jiang, Shanghai (CN); Qian-Ru Zhai, Shanghai (CN); Huan Yu, Shanghai (CN); Rui Ma, Shanghai (CN)

(73) Assignee: Micro Focus LLC, Wilmington, DE (US)

(21) Appl. No.: 18/774,916

(22) Filed: Jul. 16, 2024

(51) Int. Cl. G06F 11/36

(52) U.S. Cl. CPC G06F 11/3612

(57) ABSTRACT

Computer-interpreted scripts (“scripts”) execute instructions, such as to serve as a client in a client-server application. However, scripts may contain hardcoded temporary values that expire and, as a result, cause replaying the script to fail. By identifying the problem (e.g., an error message), gathering data available, and generating a prompt to a large language model (LLM), a resolution to the error may be provided and results in a modified script. Optionally, the resolution is evaluated, such as to correct any hallucinations of the LLM. A replay engine then replays the modified script and, if successful, the error is resolved. In one embodiment, the error is a hardcoded value that is no longer valid. Such a value is detected and replaced with a variable having a value determined form preceding operations of the script.

### FIELD OF THE DISCLOSURE

The invention relates generally to systems and methods for determining and correcting a fault in a script and particularly to automatically correcting script errors that comprise hardcoded values.

### BACKGROUND

Automated testing of software applications often requires a client application interacting with a server application. Testing client-server applications needs to simulate real data, however, the data is often dynamic, such as a session identifier or customer number. When the session ends, the dynamic data is invalidated and cannot be reused. As a result, testing the application often requires modifying the client-side application, a server-side application, or both (e.g., disabling security features, temporarily using static or enumerated data in place of dynamically generated data, etc.). This may require a highly skilled programmer and even so, may introduce errors and insert security vulnerabilities that, while expected to be removed, may not be. Alternatively, there may be rules or specific records that are only used for testing purposes. However, care must be taken not to allow such exceptions to result in a “back door” around the security or other portions of the application.

### SUMMARY

Client applications, such as web pages, often get sent from a client device to a server and comprise dynamic data. The client must return the dynamic data for subsequent requests. Examples of dynamic data include, but are not limited to, a session identifier, timestamp, customer identifier, and authentication tokens. Modifying the application (client, server, or both) opens up the opportunity for mismanagement of the applications and questionable results. For example, an application tested “should” be the same as the application delivered, but with a feature, such as generation of the customer identifier modified. However is another developer modified the code without creating a testing version, errors or other defects could go be released.

Applications may use “brute force” to generate real dynamic data, which waste processing and network resources if testing an unrelated feature is all that remains. For example, creating a new customer account each time the testing tool wants to perform tests on a shopping cart portion of an application (e.g., add items, delete items, change quantity, save without checking out, etc.) requires additional overhead to create the accounts. If such testing is performed on a production application, then additional care is required to back-out any transactions performed by the testing tool while testing the application.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method, including: executing, by a processor, a first script; receiving, by the processor, during execution of the first script, an error message identifying a first error in a first portion of the first script and terminating execution of the first script; collecting, by the processor, data corresponding to the first error; generating, by the processor, a prompt including the error, the data corresponding to the first error, and instructions to determine a resolution to the error; providing, by the processor, the prompt to an artificial intelligence (AI) and receive the resolution therefrom; creating, by the processor, a second script from the first script in accordance with the resolution; and replaying, by the processor, the second script and determine, from the execution of the second script, a success of the resolution to resolve the first error.

In some aspects, the techniques described herein relate to a method, further including evaluating, by the processor, the resolution to determine whether the error is associated with a hardcoded value and, when true, replacing the hardcoded value with a variable in the second script.

In some aspects, the techniques described herein relate to a method, further including setting the variable with a previously determined value prior to replaying the second script.

In some aspects, the techniques described herein relate to a method, further including evaluating the first script at a first preceding step occurring before the first portion of the first script, to determine a prior value for the hardcoded value.

In some aspects, the techniques described herein relate to a method, wherein the success of the resolution to resolve the first error indicates an equivalent error to the first error and, in response thereto, evaluating the first script at a second preceding step occurring before the first preceding step of the first script, to determine a second prior value for the hardcoded value.

In some aspects, the techniques described herein relate to a method, wherein the success of the resolution to resolve the first error indicates a different error to the first error, setting the first script to the second script and restarting execution of the first script.

In some aspects, the techniques described herein relate to a method, wherein collecting data corresponding to the first error includes collecting runtime logs of the first script during execution thereof.

In some aspects, the techniques described herein relate to a method, further including evaluating, by the processor, the resolution to determine to determine whether the resolution requires at least one other modification not specified by the resolution and, applying the at least one other modification to the second script.

In some aspects, the techniques described herein relate to a system, including: a data storage; and a processor coupled with a computer memory including instructions to cause the processor to perform: executing, by a processor, a first script; receiving, by the processor, during execution of the first script, an error message identifying a first error in a first portion of the first script and terminating execution of the first script; collecting, by the processor, data corresponding to the first error; generating, by the processor, a prompt including the error, the data corresponding to the first error, and instructions to determine a resolution to the error; providing, by the processor, the prompt to an artificial intelligence (AI) and receive the resolution therefrom; creating, by the processor, a second script from the first script in accordance with the resolution; and replaying, by the processor, the second script and determine, from the execution of the second script, a success of the resolution to resolve the first error.

In some aspects, the techniques described herein relate to a system, further including instructions to cause the processor to perform evaluating the resolution to determine whether the error is associated with a hardcoded value and, when true, replacing the hardcoded value with a variable in the second script.

In some aspects, the techniques described herein relate to a system, further including instructions to cause the processor to perform setting the variable with a previously determined value prior to replaying the second script.

In some aspects, the techniques described herein relate to a system, further including instructions to cause the processor to perform evaluating the first script at a first preceding step occurring before the first portion of the first script, to determine a prior value for the hardcoded value.

In some aspects, the techniques described herein relate to a system, wherein the success of the resolution to resolve the first error indicates an equivalent error to the first error and, in response thereto, evaluating the first script at a second preceding step occurring before the first preceding step of the first script, to determine a second prior value for the hardcoded value.

In some aspects, the techniques described herein relate to a system, wherein the success of the resolution to resolve the first error indicates a different error to the first error, setting the first script to the second script and restarting execution of the first script.

In some aspects, the techniques described herein relate to a system, wherein collecting data corresponding to the first error includes collecting runtime logs of the first script during execution thereof.

In some aspects, the techniques described herein relate to a system, further including instructions to cause the processor to perform evaluating, by the processor, the resolution to determine to determine whether the resolution requires at least one other modification not specified by the resolution and, applying the at least one other modification to the second script.

In some aspects, the techniques described herein relate to a non-transitory computer readable medium including instructions that, when read by a machine, cause the machine to perform: executing, by a processor, a first script; receiving, by the processor, during execution of the first script, an error message identifying a first error in a first portion of the first script and terminating execution of the first script; collecting, by the processor, data corresponding to the first error; generating, by the processor, a prompt including the error, the data corresponding to the first error, and instructions to determine a resolution to the error; providing, by the processor, the prompt to an artificial intelligence (AI) and receive the resolution therefrom; creating, by the processor, a second script from the first script in accordance with the resolution; and replaying, by the processor, the second script and determine, from the execution of the second script, a success of the resolution to resolve the first error.

In some aspects, the techniques described herein relate to a non-transitory computer readable medium further including instructions to cause the processor to perform evaluating the resolution to determine whether the error is associated with a hardcoded value and, when true, replacing the hardcoded value with a variable in the second script.

In some aspects, the techniques described herein relate to a non-transitory computer readable medium further including instructions to cause the processor to perform setting the variable with a previously determined value prior to replaying the second script.

In some aspects, the techniques described herein relate to a non-transitory computer readable medium further including instructions to cause the processor to perform evaluating the first script at a first preceding step occurring before the first portion of the first script, to determine a prior value for the hardcoded value.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a method in accordance with embodiments of the present disclosure;

FIG. 3 depicts a method in accordance with embodiments of the present disclosure;

FIG. 4 depicts a script in accordance with embodiments of the present disclosure;

FIG. 5 depicts a script in accordance with embodiments of the present disclosure; and

FIG. 6 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

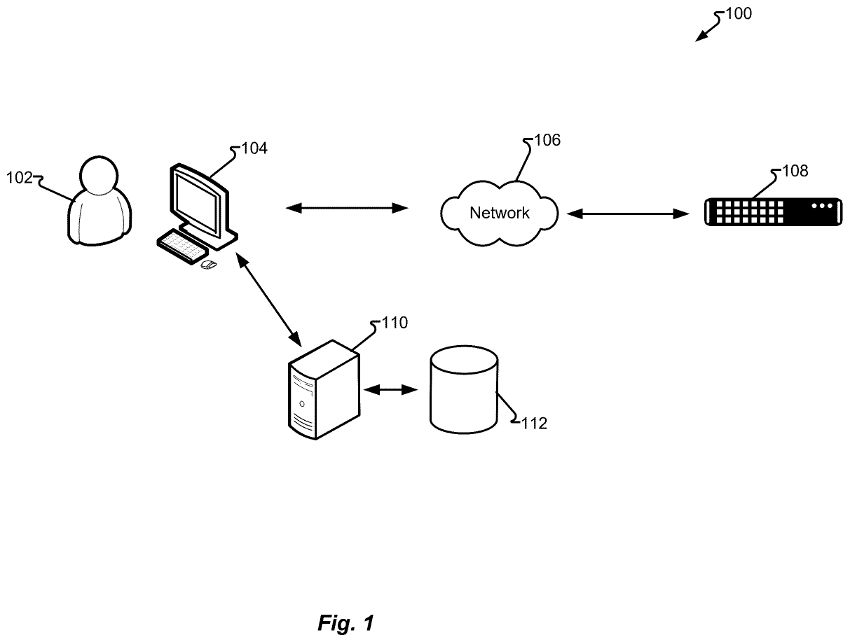

FIG. 1 illustrates system 100 in accordance with embodiments of the present disclosure. In one embodiment, system 100 illustrates components comprising computing and data storage components interconnected via network 106. It should be appreciated that, in one embodiment, each of the illustrated components provides a single service. However, one of ordinary skill in the art will recognize that other topologies may be deployed without departing from the scope of embodiments herein. For example, any one component may be embodied as a plurality of components and/or any two or more components may be embodied as a single component. In one embodiment, the components as illustrated perform a single function, in other embodiments, one or more components may perform a plurality of functions and/or one or more functions may be performed by a plurality of components including as a service (e.g., software as a service (SaaS)).

In one embodiment, user 102 executes a script. As used herein, a script is a file comprising commands. Often scripts are used to automate manual processes, such as to issue a command, execute an application, provide an input to the application, and receive an output from the application. The script is executed (i.e., interpreted) and the commands therein are executed in turn.

In one embodiment, a script executing on computer 104 executes commands, such as client operations performed by computer 104 and host or server application executed by server 108, connected computer 104 via network 106. However, a command within the script may fail and, as a result, the script may not execute successfully.

One of the benefits of a script is the ability to repeat one or more operations, such as to perform tests on the client application and/or server application. Changes to the script may be made manually, such as by user 102, and/or an automated process, such as a process of computer 110 using data stored in database 112. The modified script may then be executed and the results obtained.

Often a server application will determine a value for a variable which will change, such variables include customer numbers for different users/customers (e.g., login account), sessions, timestamps, and/or authentication tokens. For example, a script may call a server application and login with a username and password. Server 108 hen returns a value (e.g., session_ID, customer number, etc.) which is then used throughout the interaction. If the script needs to be restarted, and the script is not modified the script may fail, such as due to the script's use of a previous, but now invalid, session_ID.

In one embodiment, computer 110 monitors the interaction between computer 104 and server 108, such as by viewing user inputs, reading log files, screen imaging, message monitoring, and/or other operations. An error in a script will be determined to be the result of a particular portion of a script, such as a particular command at a particular line number within the script. The error code and script are then analyzed by a process, such as an artificial intelligent (AI) agent executing on computer 110 and/or computer 104. The analysis may optionally include and evaluate other data, such as any user inputs, graphical elements and their state, network status messages regarding network 106, and/or other data sources.

Computer 110 may then determine that a portion (e.g., a command at a line number) of a script includes a hardcoded value, such as session identifier that was previously valid but now expired or otherwise invalid. The hardcoded value in the script is then automatically modified by computer 110 to replace the hardcoded value with a variable. The value of the variable may be set in another portion of the script or other source.

In one example, an automatic correct to a script is provided. Computer 104 executes a script interacting with a server application on server 108. The script may require a login by the user (i.e., computer 104 executing the script) and receive in response a session identifier (e.g., session_ID). The script may fail at a subsequent command that uses a hardcoded value, such as for the session identifier. The script and error are provided to the AI to determine that the failure is due to a hardcoded session identifier. As a result, the script is automatically modified to replace the hardcoded value with a variable and the variable set to the session identifier. If successful, the modified script is saved. Additionally or alternatively, a different error may be obtained upon replay of the script. When the error is different, the process is repeated but wherein the analysis considers the new error. If the same error is observed on replay, then the script is traversed upward (e.g., incrementally preceding operations) to determine another value and the process is repeated until the error is resolved or there are no more earlier operations (e.g., top of the script) and other action is required (e.g., manual intervention).

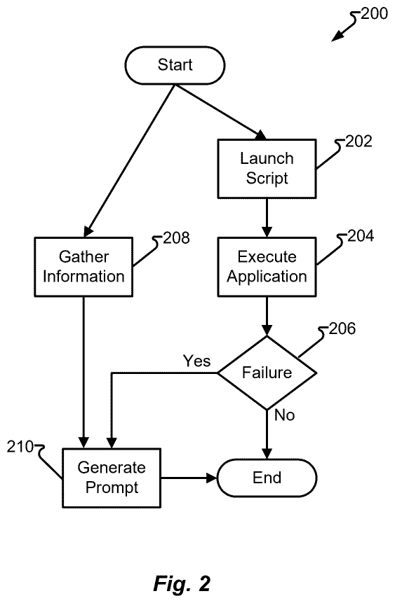

FIG. 2 depicts process 200 in accordance with embodiments of the present disclosure. In one embodiment, process 200 is embodied as machine-readable instructions maintained in a non-transitory memory that when read by a machine, such one or more processors of a server or servers, cause the machine to execute the instructions and thereby execute process 200. The processor of the server may include, but is not limited to, at least one processor of computer 104, computer 110, and/or server 108.

In one embodiment, process 200 comprises a first portion, wherein a script is executed and a success or failure determined, and a second portion, wherein data is gathered regarding the execution of the script comprising step 208. It should be appreciated that step 208 may be executed before the execution of other steps, such as before step 202, during the execution of the script, such as a parallel process to step 204, and/or after a script has ended after the execution of step 204, such as due to a failure of an operation within the script. Data gathered in step 208 may be in any computer readable or computer-human readable (e.g., XML, JSON, Base64, etc.). Similarly, sources for data may include, but are not limited to, log files, error messages, user inputs, system messages, etc.

Step 204 may comprise a plurality of steps including, but not limited to, the script launched in step 202 executing an application, such as a server application executing on server 108, providing inputs to the application, receiving outputs from the operation, executing additional applications, and combinations thereof. At test 206 a failure is determined and, if there is no failure (e.g., the script terminated normally) then process 200 ends and, optionally, data gathered in step 208 is discarded.

When test 206 is determined in the affirmative (i.e., the script ended due to a failure), processing continues wherein a prompt is generated in step 210. The generation of the prompt may include information gathered in step 208. As will be discussed more completely with respect to the embodiments that follow, once a prompt is generated, an AI receives and processes the prompt and provides modifications to the script in order to resolve the error. In response to the AI processing the prompt, a modified script may be created and re-executed via process 200 until such time as test 206 determines there are not failures.

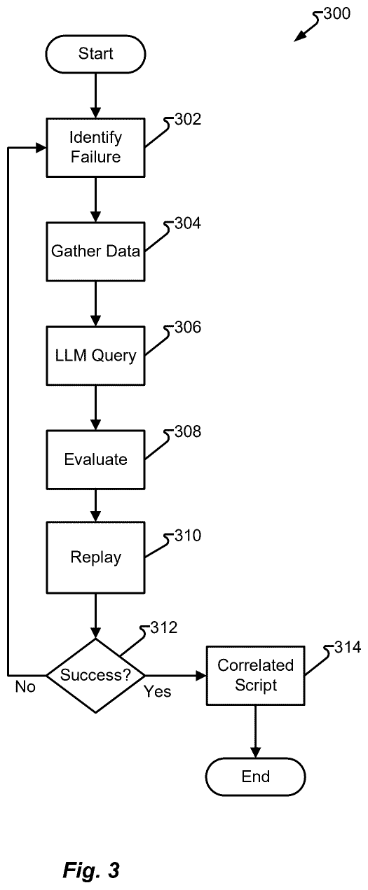

FIG. 3 depicts process 300 in accordance with embodiments of the present disclosure. In one embodiment, process 300 is embodied as machine-readable instructions maintained in a non-transitory memory that when read by a machine, such one or more processors of a server or servers, cause the machine to execute the instructions and thereby execute process 300. The processor of the server may include, but is not limited to, at least one processor of computer 104, computer 110, and/or server 108.

In one embodiment, process 300 begins and, at step 302, a failure is identified. The failure being associated with a script and further associated with a line number and a command at the line number. The determined failure may include an error code and/or description of the error. Certain errors may be determined to be the result of issues that are outside of the script and/or cannot be resolved with modifications to the script, such as a network failure (e.g., network 106 becomes inoperable). When such errors are encountered may cause process 300 to end. However, errors that result from a command in a script are processed further.

In step 304, information is gathered. The information gathered is variously embodied and includes, but is not limited to, the error returned (e.g., error code, error description, etc.), the script, line number associated with the last command prior to the failure, system variables, etc.

Step 306 generates a prompt and, with the prompt, queries a large language model (LLM) and receives a resolution in response. In one embodiment, generating the prompt comprises a processor executing instructions to generate a prompt comprising: compare two or more responses, such as from an error, to find a dynamic value in the response; a request to identify a dynamic value in a response; and/or formation of the response instructions. One example of a template for a prompt is:

```
  web_reg_save_param_json(
    “ParamName=<Name>”,
    “QueryString=<JsonPath>”
    SEARCH_FILTERS,
    “Scope=Body”,
    “LAST”);
  Give a meaningful variable name <ParamName> based on the dynamic
value name in both of the response.
  Convert provided C style script with the following sub-steps 4.a and
  4.b, wherein:
  4.a. Replace the dynamic value in the script with the PramaName we
  defined in the C style function in fomart “{{<ParamName>}}”
  4.b. Add function web_reg_save_param_json we created in step 3
  before the function at line {3}.
  5.Do not add any other code
```

The template is then populated. One example of a completed prompt is:

```
The replay of C vugen script failed at line 30:
  web_submit_data(“validate_request_simple.asp”,
      “Action=http://web-kalimanjaro.aws.swinfra.net/cgi-
bin/json/validate_request_simple.asp”,
      “Method=POST”,
      “RecContentType=text/html”,
      “Referer=http://web-kalimanjaro.aws.swinfra.net/cgi-
bin/json/json_correlation_simple.asp”,
      “Snapshot=t3.inf”,
      “Mode=HTML”,
      ITEMDATA,
      “Name=my_session”, “Value=MC4GaDbro5jmK6k”, ENDITEM,
      LAST);
      The replay error is:
      Action.c(30): web_submit_data(“validate_request_simple.asp”) started
      [MsgId: MMSG-26355]
      Action.c(30): Error -26611: HTTP Status-Code=500 (Wrong Session ID sent!) for
  “http://web-kalimanjaro.aws.swinfra.net/cgi-bin/json/validate_request_simple.asp”
      [MsgId: MERR-26611]
      Action.c(30): web_submit_data(“validate_request_simple.asp”) highest severity
  level was “ERROR”, 1208 body bytes, 207 header bytes [MsgId: MMSG-26388]
      Ending action Action.
      Ending iteration 2.
      Ending Vuser...
  Starting action vuser_end.
  Ending action vuser_end.
  Vuser Terminated.
  Now I give you two replay responses of the earlier step at line 16, please convert the C
  style script according to the following process (Step1-Step4).
  [Workflow]
  1. Compare 2 responses and find the dynamic values in response
  2. Use JSON path to identify the dynamic value in the response
  3. Save the json path to a variable, in the C style function, for example:
  web_reg_save_param_json(
    “ParamName=< Name>”,
    “QueryString=< JsonPath>”,
    SEARCH_FILTERS,
    “Scope=Body”,
    “LAST”);
  Give a meaningful variable name <ParamName> based on the dynamic value name in
  both of the response.
  4. Convert provided C style script with the following sub-steps 4.a and 4.b
  4.a. Replace the dynamic value in the script with the PramaName we defined in the C
  style function in fomart “{{<ParamName>}}”
  4.b. Add function web_reg_save_param_json we created in step 3 before the function at
  line {3}.
  5.Do not add any other code
```

The prompt is then provided to a large language model (LLM) and a response received therefrom. Next, in step 308 the reply is evaluated. Step 308 may be optional and omitted if the output from the LLM is stable and consistent. However, LLMs may produce different results even when given the same inputs. As a result, step 308 evaluates the response from the LLM to determine any other operations that are necessary and/or modifications to the operations provided in the response from the LLM. As a result, a modified script is produced and, in step 310, the script, as modified, replayed such as by a replay engine.

Test 312 determines if there is success and, if true, the script is successfully correlated script results in step 314 that modifies the hardcoded values into variables to be executed without error. If test 312 determines there is not successful, such as the same error is observed with the modified script, the process repeats back at step 302. A resolution is not successful may be determined when a subsequent error indicates an identical error or a similar error, such as a different timestamp or an indication that the subject of the error is the same while the error itself may have changed (e.g., expired session identifier and an invalid format for a session identifier). In subsequent iterations, step 302 may further include the new error and optionally past errors.

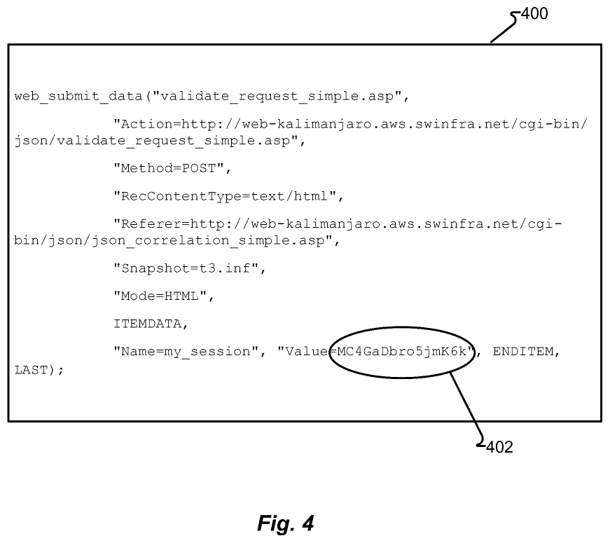

FIG. 4 depicts script 400 in accordance with embodiments of the present disclosure. In one embodiment, script 400 includes hardcoded value 402 for a session identifier.

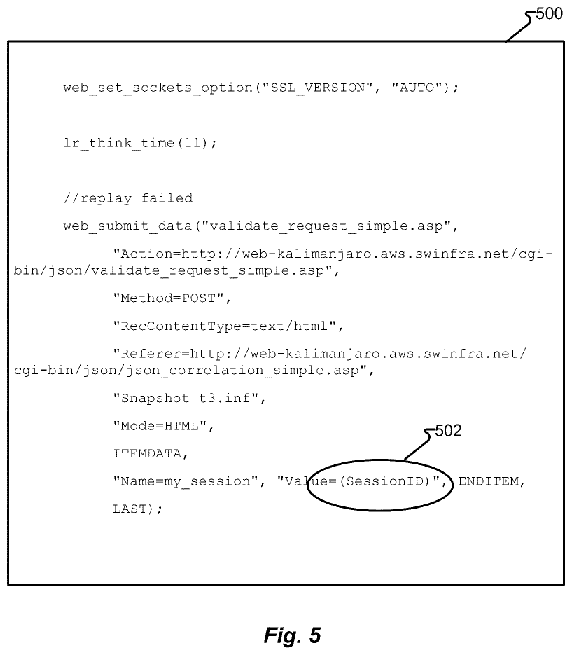

FIG. 5 depicts script 500 in accordance with embodiments of the present disclosure. In one embodiment, script 500 is a modified script from script 400, which replace hardcoded value 402 for a session identifier with a variable generated by the LLM in response to the prompt. The value of the variable may then be set corresponding to an actual value returned without further modification to the script being required.

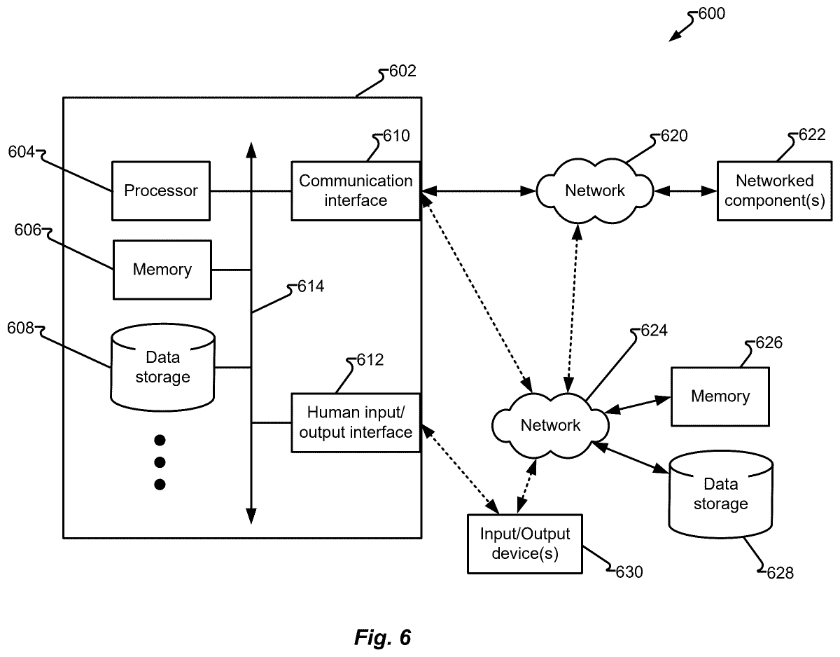

FIG. 6 depicts device 602 in system 600 in accordance with embodiments of the present disclosure. In one embodiment, computer 104, computer 110, and/or server 108 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise programmable logic functionality, such as determined, at least in part, from accessing machine-readable instructions maintained in a non-transitory data storage, such as database 112, which may be embodied as circuitry, on-chip read-only memory, computer memory 606, data storage 608, etc., that cause the processor 604 to perform the steps of the instructions. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize computer memory 606 and/or data storage 608 for the storage of accessible data, such as instructions, values, etc. Communication interface 610 facilitates communication with components, such as processor 604 via bus 614 with components not accessible via bus 614 and may be embodied as a network interface (e.g., ethernet card, wireless networking components, USB port, etc.). Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or configured to utilize one or more networks, such as network 620 and/or network 624.

Network 106 may be embodied, in whole or in part, as network 620. Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) than networked components 622, which may be connected to network 620 comprising a public network (e.g., Internet) that may not be as trusted.

Components attached to network 624 may include computer memory 626, data storage 628, input/output device(s) 630, and/or other components that may be accessible to processor 604. For example, computer memory 626 and/or data storage 628 may supplement or supplant computer memory 606 and/or data storage 608 entirely or for a particular task or purpose. As another example, computer memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of computer memory 606, data storage 608, computer memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, a switch, a port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
executing, by a processor, a first script;
receiving, by the processor, during execution of the first script, an error message identifying a first error in a first portion of the first script and terminating execution of the first script;
collecting, by the processor, data corresponding to the first error;
generating, by the processor, a prompt comprising the error, the data corresponding to the first error, and instructions to determine a resolution to the error;
providing, by the processor, the prompt to an artificial intelligence (AI) and receive the resolution therefrom;
creating, by the processor, a second script from the first script in accordance with the resolution; and
replaying, by the processor, the second script and determine, from the execution of the second script, a success of the resolution to resolve the first error.

2. The method of claim 1, further comprising evaluating, by the processor, the resolution to determine whether the error is associated with a hardcoded value and, when true, replacing the hardcoded value with a variable in the second script.

3. The method of claim 2, further comprising setting the variable with a previously determined value prior to replaying the second script.

4. The method of claim 2, further comprising evaluating the first script at a first preceding step occurring before the first portion of the first script, to determine a prior value for the hardcoded value.

5. The method of claim 4, wherein the success of the resolution to resolve the first error indicates an equivalent error to the first error and, in response thereto, evaluating the first script at a second preceding step occurring before the first preceding step of the first script, to determine a second prior value for the hardcoded value.

6. The method of claim 4, wherein the success of the resolution to resolve the first error indicates a different error to the first error, setting the first script to the second script and restarting execution of the first script.

7. The method of claim 1, wherein collecting data corresponding to the first error comprises collecting runtime logs of the first script during execution thereof.

8. The method of claim 1, further comprising evaluating, by the processor, the resolution to determine to determine whether the resolution requires at least one other modification not specified by the resolution and, applying the at least one other modification to the second script.

9. A system, comprising:
a data storage; and
a processor coupled with a computer memory comprising instructions to cause the processor to perform:
executing, by a processor, a first script;
receiving, by the processor, during execution of the first script, an error message identifying a first error in a first portion of the first script and terminating execution of the first script;
collecting, by the processor, data corresponding to the first error;
generating, by the processor, a prompt comprising the error, the data corresponding to the first error, and instructions to determine a resolution to the error;
providing, by the processor, the prompt to an artificial intelligence (AI) and receive the resolution therefrom;
creating, by the processor, a second script from the first script in accordance with the resolution; and
replaying, by the processor, the second script and determine, from the execution of the second script, a success of the resolution to resolve the first error.

10. The system of claim 9, further comprising instructions to cause the processor to perform evaluating the resolution to determine whether the error is associated with a hardcoded value and, when true, replacing the hardcoded value with a variable in the second script.

11. The system of claim 10, further comprising instructions to cause the processor to perform setting the variable with a previously determined value prior to replaying the second script.

12. The system of claim 10, further comprising instructions to cause the processor to perform evaluating the first script at a first preceding step occurring before the first portion of the first script, to determine a prior value for the hardcoded value.

13. The system of claim 12, wherein the success of the resolution to resolve the first error indicates an equivalent error to the first error and, in response thereto, evaluating the first script at a second preceding step occurring before the first preceding step of the first script, to determine a second prior value for the hardcoded value.

14. The system of claim 12, wherein the success of the resolution to resolve the first error indicates a different error to the first error, setting the first script to the second script and restarting execution of the first script.

15. The system of claim 9, wherein collecting data corresponding to the first error comprises collecting runtime logs of the first script during execution thereof.

16. The system of claim 9, further comprising instructions to cause the processor to perform evaluating, by the processor, the resolution to determine to determine whether the resolution requires at least one other modification not specified by the resolution and, applying the at least one other modification to the second script.

17. A non-transitory computer readable medium comprising instructions that, when read by a machine, cause the machine to perform:
executing, by a processor, a first script;
receiving, by the processor, during execution of the first script, an error message identifying a first error in a first portion of the first script and terminating execution of the first script;
collecting, by the processor, data corresponding to the first error;
generating, by the processor, a prompt comprising the error, the data corresponding to the first error, and instructions to determine a resolution to the error;
providing, by the processor, the prompt to an artificial intelligence (AI) and receive the resolution therefrom;
creating, by the processor, a second script from the first script in accordance with the resolution; and
replaying, by the processor, the second script and determine, from the execution of the second script, a success of the resolution to resolve the first error.

18. The non-transitory computer readable medium of claim 17 further comprising instructions to cause the processor to perform evaluating the resolution to determine whether the error is associated with a hardcoded value and, when true, replacing the hardcoded value with a variable in the second script.

19. The non-transitory computer readable medium of claim 18 further comprising instructions to cause the processor to perform setting the variable with a previously determined value prior to replaying the second script.

20. The non-transitory computer readable medium of claim 18 further comprising instructions to cause the processor to perform evaluating the first script at a first preceding step occurring before the first portion of the first script, to determine a prior value for the hardcoded value.
